(19) United States
(12) Patent Application Publication
(10) Pub. No.: US 2025/0138545 A1
(43) Pub. Date: May 1, 2025

(54) AI TIME CONTROL OF GARDEN DEVICES WITH USER REVIEW

(71) Applicant: AL-KO Geräte GmbH, Kötz (DE)

(72) Inventor: Daniel Trumpp, Diedorf (DE)

(21) Appl. No.: 18/930,788

(22) Filed: Oct. 29, 2024

(30) Foreign Application Priority Data
Oct. 30, 2023 (EP) 23 206 658.9

(51) Int. Cl. G05D 1/229; A01D 34/00; A01D 101/00; G05D 1/648; G05D 101/15; G05D 105/15; G05D 107/20

(52) U.S. Cl. CPC G05D 1/229; A01D 34/008; G05D 1/6486; A01D 2101/00; G05D 2101/15; G05D 2105/15; G05D 2107/23

(57) ABSTRACT

The invention relates to a computer-implemented method for determining a time window for operation (TWO) of a garden device (100), in particular a mowing robot (101), a garden tractor (102) or a mower (103). The time window for operation (TWO) is determined according to input data (ID), e.g. weather data, lawn characteristics data and user profile data, by means of a grass growth simulation (201) and/or by means of a trained AI system (202) and proposed to the user for evaluation. Training data (TD) can be generated based on the user evaluation data (UED) in order to train the AI system (202). Improved garden device deployment plans can be generated by training the AI system (202) with the generated training data (TD).

### CROSS REFERENCE

The present Application for Patent claims priority to European Patent Application No. 23 206 658.9 by TRUMPP, entitled “AI TIME CONTROL OF GARDEN DEVICES WITH USER REVIEW,” filed Oct. 30, 2023, assigned to the assignee hereof, and expressly incorporated by reference herein.

### DESCRIPTION

The disclosure relates to the control of mobile garden devices for maintaining a lawn. Such garden devices may be mowing robots, garden tractors, mowers or other mobile or stationary devices for gardening, park and landscape work.

The disclosure is based on a further development of the technical teaching of European patent application EP23172108.5, filed on 08.05.2023, the contents of which are hereby fully incorporated by reference as the contents of this application.

In practice, lawns are often mowed at the manual request of a user or at predetermined regular intervals, e.g. daily or weekly. It is still common, especially with mowing robots, for lawns to be mowed daily.

A method for autonomously mowing a lawn is known from US 2017/0020064 A1. The mowing robot includes a sensor for measuring the grass height. The mowing schedule can be adjusted based on fluctuating weather information.

The disclosure relates to the intelligent deployment planning and control of garden devices. There may be a need for the deployment of garden devices, e.g. a mowing robot, to be automatically adapted to changing environmental conditions and user preferences. For example, the lawn should ideally be mowed automatically when a certain height of grass is reached. Furthermore, the lawn should not be mowed during rainy or other restricted periods. The operational planning and configuration can refer to both a fully automated garden device (e.g. a mowing robot) or a semi-automated garden device (e.g. a garden tractor with a mower deck) that is operated with technical support from a human.

In the case of mowing robots, both the start time and the mowing duration are of particular importance. Chaotically navigating mowing robots that mow the lawn in more or less random paths need sufficient time to mow the lawn completely and evenly, whereby the speed can also depend on the grass height. For an optimal mowing time, it is therefore desirable to optimise between efficiency and quality of the mowing result.

It is known from the prior art to plan the operating times of garden devices by processing rain sensor data or weather data.

It is also known to estimate the grass growth with a grass growth simulation, i.e. to calculate it in a model-based way, to predict the next mowing operation. The grass growth simulation can be fed with weather data and data from the lawn in question. Static or dynamic exclusion times (e.g. Sundays and holidays, rainy periods, night times) can also be taken into account. Such methods for determining a suitable time window for operation of the garden device based on a grass growth simulation are referred to here as ‘simulative methods’.

The disadvantage of simulative methods is that they do not yet offer sufficient accuracy, consideration of local peculiarities or adaptability to user needs.

The object of the disclosure is to present an improved technique for planning and controlling the use of garden devices. The disclosure solves the problem with the features of the independent claims.

The disclosure is based on the idea that deployment scheduling can be improved by training an AI system based on simulative generated time windows for operation that have been evaluated by users. Alternatively or in addition to simulative generated time windows for operation, other initial work planning procedures can be used. For training, time windows for the next operation of the garden device are first generated using a simulative method, i.e. based on a grass growth simulation, which are provided to the user for evaluation before and/or after the operation of the garden device. The user is asked to evaluate, i.e. to review, the time window and, if useful, other parameters in order to generate training data sets for training an AI system. User evaluation can be understood as a review or rating of machine generated time window by the user to technically improve the automatic generation of such time windows. On the basis of the training data sets, the AI system, preferably an artificial neural network, in particular a time series model, can be trained to determine the optimal time window for future use of the garden device instead of the simulative method with grass growth simulation (or another initial work planning method).

The disclosure can be applied with different initial work planning procedures. The initial work planning procedure refers to a procedure for determining time windows for operation that is used, at least on a transitional basis, to generate training data in order to subsequently train the AI system with the training data. After sufficient training, the AI system can replace and/or supplement the initial work planning procedure.

The AI system may also be referred to as an AI model, a mowing schedule model or a smart mowing model. Several known trainable models (e.g. artificial neural networks) are available to the person skilled in the art.

The AI system is preferably designed as a time series model. Put simply, the AI system provides the desired output data (start time, duration of operation, etc.) for suitably structured input data (weather data, gardening tool data, lawn characteristics data, etc.). The present disclosure covers both the initial procedure for the preparatory collection of training data (e.g. for the initial training of the AI system prior to its use) and the operating procedure of the trained AI system. Preferably, further training data is also continuously collected during the operation of the AI system to improve it. The disclosure also includes examples as a mere operating procedure of the AI system without further user evaluation and/or generation of training data.

In the following disclosure, the simulative method with a grass growth simulation as the initial work planning method is described by way of example. In some or all the described or claimed examples, a different initial work planning method or only the AI system can be used as an alternative or in addition to the simulative method.

Another possible initial work planning procedure is to use time windows for operation that are manually specified by the user. These manually specified time windows for operation can be used to generate an evaluation query, possibly with the addition of additional operation data (e.g. sensor data from the garden device). When the function for training the AI model is activated, training data is generated based on the evaluated time windows for operation.

Alternatively or additionally, a user-configurable rule can be used as the initial work plan procedure, e.g. by specifying a time interval and a duration. The evaluation query and/or additional operation data (e.g. sensor data from the garden device) can be used to improve these time windows for operation that have been generated by simple rules.

Another possible initial work planning procedure uses randomly generated time windows for operation. In particular, time windows for operation that have been generated with a heuristic and/or a rule that can be configured by the user can be varied with randomly generated values. These randomly generated time windows for operation can be used (if useful with operation data) for the evaluation process and for generating training data.

The trained AI system preferably uses similar or the same input data as the simulative method. Preferably, the time window for operation is determined on the basis of input data, the weather data (e.g. measurement data and/or forecasts from an online weather service for the location of the lawn to be maintained), garden device data (e.g. type of garden device, area performance, etc.), user profile data (e.g. user settings, personal exclusion times, threshold values for grass height, etc.), lawn characteristics data (e.g. location, area and shape of the lawn, grass type, watering, soil conditions, etc.), historical operating data (e.g. time of last lawn care) and/or calendar data (e.g. Sundays and holidays).

Preferably, both the simulative method with the grass growth simulation and the AI system determine a time window for operation with a start time and/or a duration of operation for a future operation of the garden device. In the simulative method, grass growth since the last lawn care is estimated using a grass growth simulation based on weather and lawn data.

As soon as the simulation predicts a grass height, i.e. an accumulated grass growth, above a configurable threshold value, the next use of the garden device can be planned. The exact start time and duration of the operation can be adapted to further conditions (e.g. wetness during and after rain, exclusion of rest periods). Various possible examples of a simulative method with grass growth simulation in the sense of this disclosure can be found in the European patent application EP23172108.5, to which this application refers.

In this disclosure, the term ‘time window for operation’ is used as a generic term for a proposed time window for operation and, if applicable, rectified time windows for operation. Depending on the example, the time window for operation may consist only of a start time (e.g. for hand-held mowers) or a start time and a duration of operation (e.g. for automated mowing robots). The duration of operation can be determined dynamically or can be fixed.

The advantage of the trained AI system is that, by training it with data from evaluated past operations, a wide range of influences (e.g. local characteristics of the lawn, user preferences, model errors, configuration errors) can be taken into account better or without explicit configuration by the user. Over time, the user automatically receives better time suggestions for maintaining their garden that better suit their personal preferences and the actual conditions.

The evaluation query can be carried out in several ways, depending on the form of execution and the time of the query, i.e. before or after the deployment. The evaluation query is provided on a user's terminal device, e.g. via an app on a smartphone or via a web app in a web browser. The evaluation query is structured in such a way that the user is prompted to enter the predetermined user evaluation data. Preferably, the data to be evaluated is displayed (e.g. the proposed time window for operation). The evaluation query can include several query steps, which can build on each other and include both qualitative (e.g. good, bad, longer, shorter, earlier, later) and quantitative evaluations (e.g. desired start time, desired duration of operation, x hours/days earlier/later, x hours shorter/longer).

In an example, the user evaluation data includes at least a qualitative evaluation (e.g. I like it/I don't like it) of the start time and/or the duration of operation of the time window for operation. At the time of the evaluation, the time window for operation may be in the past, present or future. If the user gives a negative evaluation to one aspect of the time window for operation, further user evaluation data for this aspect is preferably requested (e.g. the desired time window for operation, a desired start time, a desired duration of operation, earlier or later, more or less grass growth before mowing).

By evaluating the time window for operation suggested by the machine, a training data set can be generated with additional information on the suitability of the suggested time window for operation, which can be used to improve the system through machine learning. Qualitative evaluations can be used, for example, for reinforcement learning. Alternatively or additionally, training data sets for supervised learning can be generated from quantitative evaluations, in particular with explicit desired values for the time window for operation as ‘true’ output data, in combination with the associated input data.

Thanks to the method, it is possible for the user to train the system to generate suitable time windows for operation of his garden device without the need for the manufacturer to manually generate training data. The user can achieve a user-specific improvement of the system during operation by means of his assessments, which relate to his personal preferences, his individual garden and his individual garden device. The training for the user is intuitive by answering the evaluation query.

Alternatively or additionally, the user can also use their evaluations to improve a system that is used for a large number of users and devices. The evaluations provided by a large number of users allow large amounts of training data to be collected, which can be used in whole or in part to train a shared system.

If the user evaluates the time window for operation in advance, the user evaluation data can be used to rectify the time window for operation for: controlling the garden device. Preferably, a rectified time window for operation is generated on the basis of the user evaluation data, which is then used to control the garden device instead of the originally proposed time window for operation. To generate training data, rectified time windows for operation can be generated on the basis of subsequent user assessments, even if the operation has already been carried out.

If the user assesses the time window for operation retrospectively, the actual time window for operation and/or the work result (e.g. evenness of the mown area) can be assessed. In addition, operation data (e.g. sensor data from the garden device or actual weather data recorded) can be taken into account.

In particular, several evaluation queries can be carried out for the same operation of the garden device. For example, an evaluation query about the predicted time window for operation can be carried out in advance, another evaluation query shortly before on the same day of the time window for operation, and another evaluation query after the operation has ended. Depending on when the user is queried, the user and the system have different information. For example, on the day of the planned time window for operation, the user may estimate whether the current grass height already corresponds to the desired threshold for grass growth, above which mowing should take place. After the operation is complete, the user can assess the duration of the mowing operation based on the condition of the mowed lawn.

In particular, the evaluation query may include a push notification at one or more predetermined times. The evaluation query can be updated if, for example, the time window for operation has been recalculated due to a change in the weather forecast or the operation has since taken place in the past. Alternatively or additionally, the user can also enter user evaluation data on their own initiative, for example via an operation history.

The time windows for operation generated by simulation or the AI system are used to control the garden device. In the case of an automatically controlled garden device (e.g. a mowing robot), the time window for operation can be transferred to the control system of the garden device via a device interface. For semi-automated garden devices (e.g. mowers or garden tractors for manual operation), the time window for operation can be transferred via the device interface to the garden device itself or to a user terminal device (e.g. smartphone) as a user aid.

Based on the predicted time window for operation and the user evaluation data, training data sets can be generated and stored in a training data base. This training data can be used to train an AI system that can generate better operating time window suggestions based on new input data. The training can be carried out both initially when the AI system is first put into operation and to incrementally improve the AI system. Preferably, the system is trained in regular update cycles.

Preferably, a common AI system is used for multiple users and/or devices. The AI system can be trained with training data from a variety of users or devices. Advantageously, the AI system is designed to process user-specific input data. In particular, the combination of a cross-user AI system and/or cross-user training and user-specific input data enables effective improvement of the system through large amounts of training data and user-specific work schedules.

Alternatively or additionally, a customised AI system can be used for the user or a user scenario (combination of user, garden device and/or lawn), which can be specifically trained for the user or user scenario. It is more advantageous to use AI systems that have been pre-trained generically and can then be retrained with training data specific to the user or user scenario.

The AI system can be used instead of or in addition to the simulative method with grass growth simulation to determine suitable time windows for operation. In particular, it is possible to compare the results of the simulative method and the AI system and/or to have them evaluated by the user.

The disclosure enables a temporal control of garden devices that is more efficient in the use of resources and better adapted to the individual circumstances of the garden device's application scenario.

Further examples and advantageous features will be described below with reference to the drawings.

The disclosure is shown in the drawings in an exemplary and schematic manner. These show:

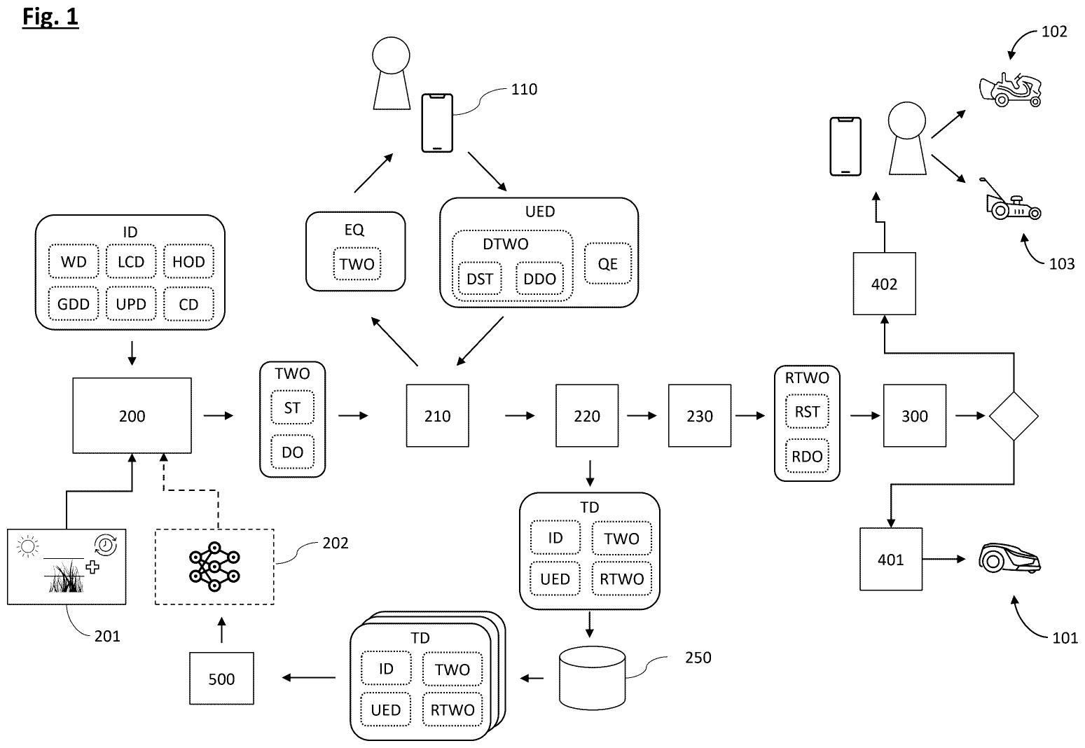

FIG. 1: a flowchart of one possible way of implementing the procedure, with user evaluation in advance and correction of the time window for operation before using the garden device;

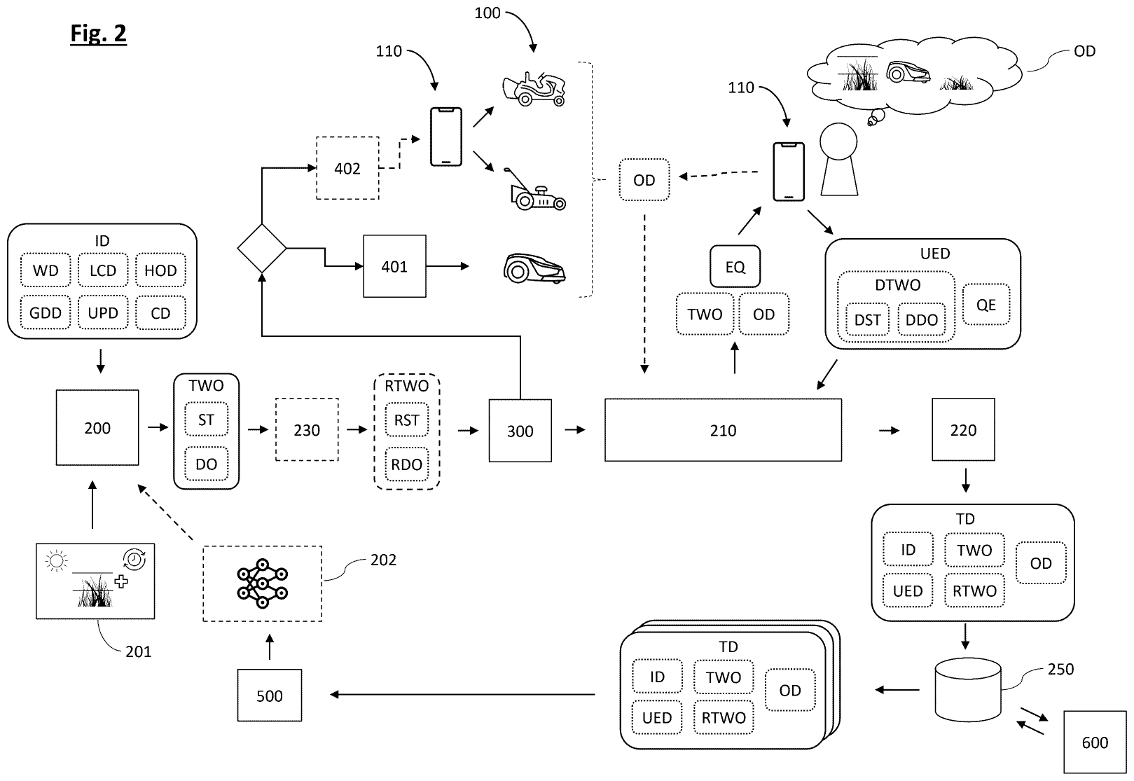

FIG. 2: a flow chart of a further example of the method with user evaluation after using the garden device;

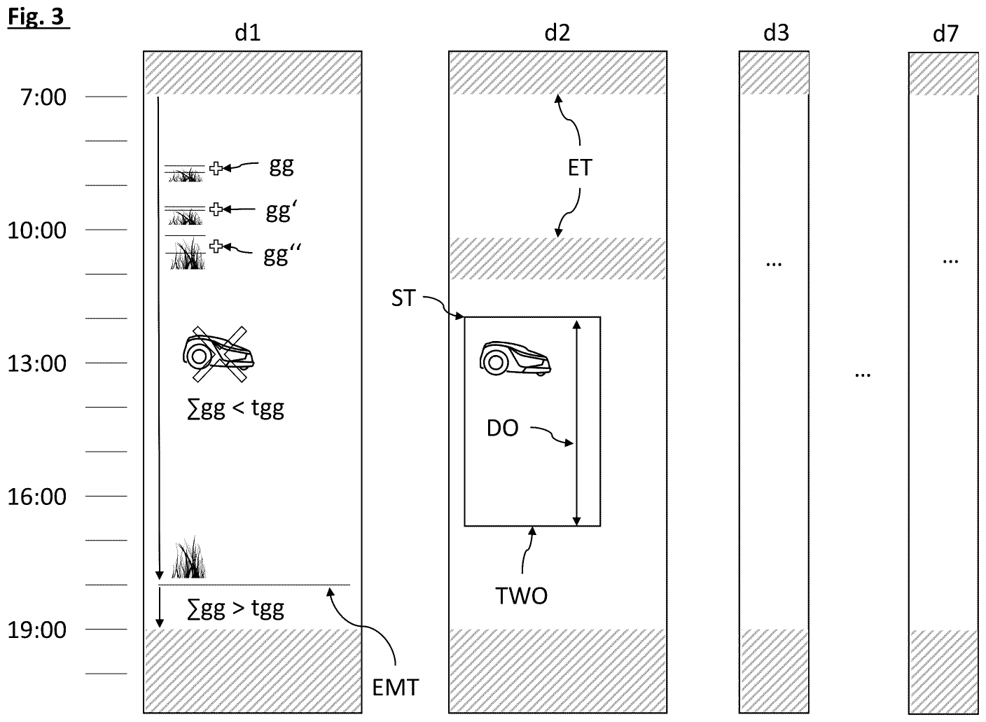

FIG. 3: Method of operation of a simulative process with grass growth simulation;

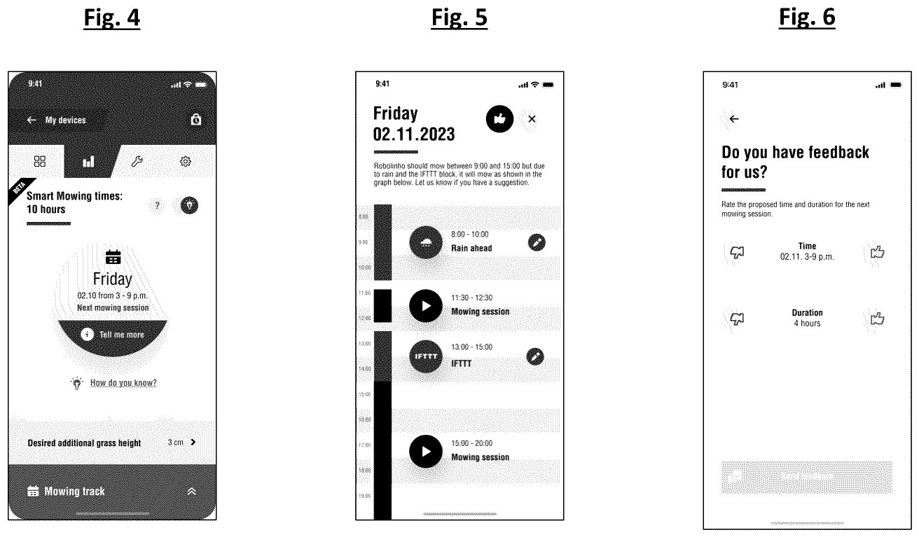

FIG. 4: Display of a planned time window for operation for a mowing robot in an app;

FIG. 5: Display of a schedule for rainy seasons, mowing times and exclusion times in an app;

FIG. 6: Representation of an evaluation query in an app;

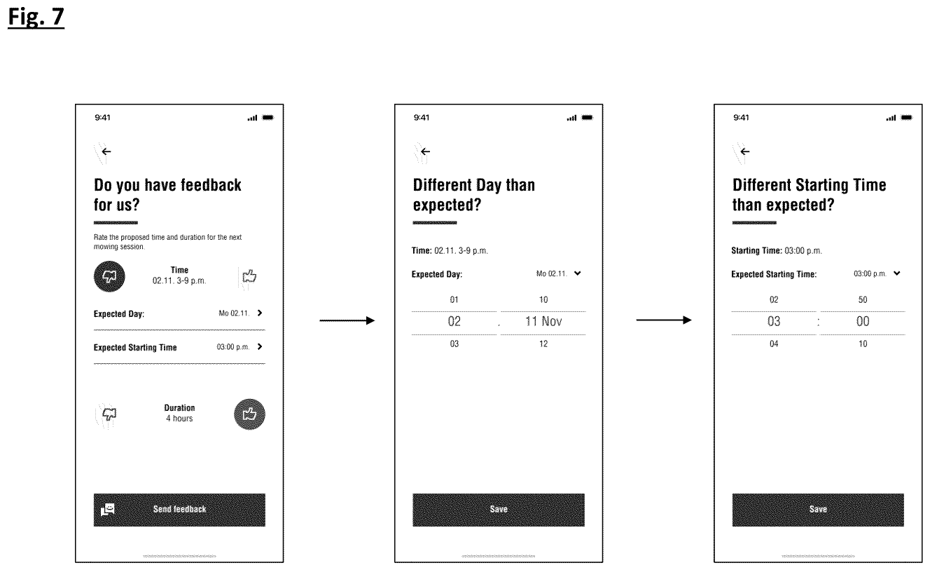

FIG. 7: Structure of structured evaluation query with user evaluation data input in an app;

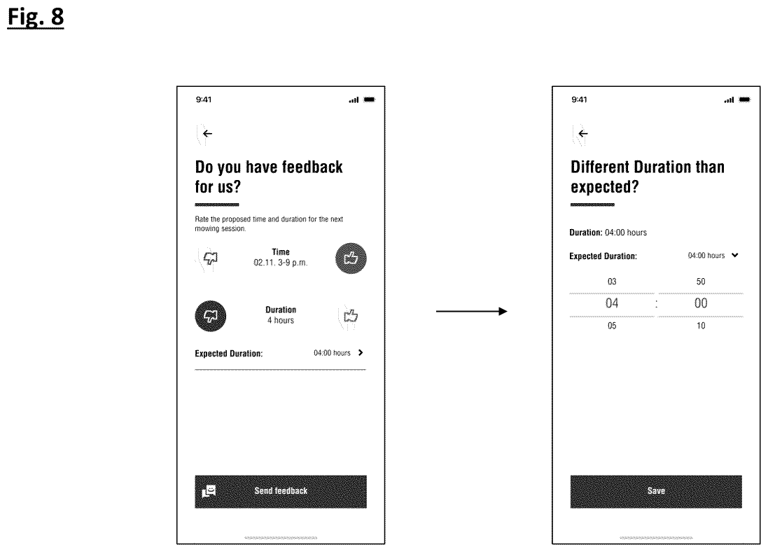

FIG. 8: Process of structured evaluation query with input of user evaluation data in an app.

Two possible examples of the computer-implemented method are shown in FIGS. 1 and 2. The computer-implemented method can be described with several procedural steps, which can be carried out in addition to the illustrated and described order also in a different order.

At the beginning of the process described, operation planning is carried out (200). In a simulative process with a grass growth simulation (201) and/or with a trained AI system (202), a time window for operation (TWO) is determined for a future use of the garden device (100). To determine the time window for operation (TWO), several input data (ID) are processed. Preferably, weather data (WD), lawn characteristics data (LCD), garden device data (GDD), historic operating data (HOD) and/or calendar data (CD) are processed as input data (ID). The disclosure explicitly includes every possible combination of the input data (ID) disclosed herein. The functioning of the simulative method is explained in more detail below with reference to FIG. 3.

The next step in FIG. 1 is an evaluation process (210). An evaluation query (EQ) of the time window for operation (TWO) is generated and provided on a terminal device (110). The user can have the proposed time window for operation (TWO) displayed in an app, for example as shown in FIGS. 4, 5 and 6. In particular, the user can start the evaluation by pressing a corresponding button. The user enters his user evaluation data (UED). The user evaluation data (UED) can include various qualitative and/or quantitative evaluations. Preferably, a qualitative evaluation (QE) of the time window for operation (TWO) or the start time (ST) and/or the duration of operation (DO) is entered. The qualitative evaluation can, for example, include a positive (‘like’, thumbs up, etc.) or negative (‘dislike’, thumbs down, etc.) evaluation. Alternatively or additionally, the user evaluation data can include quantitative evaluations, for example, a desired time window for operation (DTWO), a desired start time (DST), or a desired duration of operation (DDO). Instead of the explicit times or durations, the user can also enter other forms of evaluation to adjust the time window for operation.

The user evaluation data (UED) is stored, preferably in connection with the associated evaluated time window for operation (TWO) and/or the associated input data (ID) that was used to determine the time window for operation.

In a further step (220), a training data set (TD) is generated. The training data set (TD) preferably includes the evaluated time window for operation (TWO), the associated user evaluation data (UED), the associated input data (ID) and, if applicable, a rectified time window for operation (RWTO). The training data set (TD) may also include only some of this data and/or additional data. In particular, training data can be derived from the user evaluation data (UED) in an intermediate step. For example, a target value can be calculated from a qualitative evaluation (e.g. ‘later start time’) and/or a quantitative evaluation (e.g. ‘mow an hour longer’) in an intermediate calculation step.

The training data set (TD) is preferably stored in a training data base (250). The training data base (250) can be provided specifically for the user or the respective user scenario.

In a particularly advantageous example, the training data sets (TD) can be weighted as a function of the user evaluation data (UED) and/or other weighting factors (e.g. trustworthiness of the user, plausibility of the evaluation data). The assigned weight can be used in particular in the training process of the AI system (202) in order to take certain training data into account to a greater extent. In this way, ratings from certain users in particular can be given more weight in the training of the system than others.

In a further optional step (230), a rectified time window for operation (RTWO) is calculated. Preferably, the rectified time window for operation (RTWO), the rectified start time (RST) and/or the rectified duration of operation (RDO) are determined on the basis of the user evaluation data (UED), if useful with intermediate calculation steps. In the some cases, the time window for operation, the start time and/or the duration of operation are replaced with a time window for operation (DTWO) explicitly requested by the user, a desired start time (DST) and/or a desired duration of operation (DDO). Alternatively or additionally, the values of the corrected time window for operation can be determined from intermediate calculations, in particular on the basis of qualitative evaluations with an indication of direction (e.g. later, earlier, longer, shorter) using predefined calculation methods or heuristics.

Preferably, the input data (e.g. exclusion times from the user profile or rainy seasons) are also taken into account when calculating the rectified time window for operation (RTWO).

The step of calculating the rectified time window for operation (230) preferably takes place before the training data set (TD) is stored, so that the rectified time window for operation (RTWO) can be included in the training data set (TD).

In a further step (300), the garden device (100) is activated. The garden device (100), preferably a robotic lawn mower (101), a garden tractor (102) or a manually pushed mower (103), is activated via a control interface (401, 402). In the case of an automated mowing robot (101), the time window for operation (TWO) or a rectified time window for operation (RTWO) can be transmitted directly via a control interface (401) to a controller of the garden device, so that the garden device is activated at the start time. In the case of a semi-automated garden device (e.g. a garden tractor), the time window for operation can be provided via a message interface (402) on a user's terminal device. In this case, the user can be given recommendations for operating the garden device, which can be implemented by the user.

In an advantageous example, fleets of several garden devices of the same or different types can also be controlled. The time windows for operation can be generated for a single garden device or for several garden devices. Alternatively or additionally, the time windows for operation can be coordinated between the garden devices and/or lawns.

After a sufficient number of training data sets (TD) have been collected, the AI system (202) can be trained for the first time or retrained. In one step (500), the AI system (202) is trained with training data (TD). The training is preferably carried out asynchronously with the operation of the process, for example at maintenance intervals or after a sufficient number of training data sets has been reached.

As soon as the AI system (202) has been at least initially trained, the AI system (202) can be used in addition to or instead of the simulative method with grass growth simulation (201) to determine suitable time windows for operation.

FIG. 2 shows an example of the method in which an evaluation process (210) is carried out after the device control (300), i.e. after the garden device (100) has been used in a previously determined time window for operation (TWO) or a rectified time window for operation (RTWO).

If the evaluated use of the garden device has already taken place or is still in progress, not only the time window for operation (TWO) but also the operation data (OD) can be taken into account in the user evaluation (210). The operation data (OD) can be obtained from a garden device (100), for example from a control unit or a sensor system of the mowing robot, and/or entered via a terminal device (110). The operation data (OD) can include operating data of the garden device (100) and/or data on the progress or result of the operation of the garden device (100).

In possible examples, the operation data (OD) may, for example, record the mowing resistance of a mowing robot during the operation or the: actual duration of the mowing operation of a garden tractor. Alternatively or additionally, the user can enter the result of the operation, e.g. the quality of the cut or the grass height, as operation data.

The operation data (OD) can be the subject of the evaluation query (EQ) either as an alternative to or in addition to the time window for operation (TWO). For example, the user can be asked whether he is satisfied with the result of the mowing operation or whether the duration of the mowing operation was suitable, since the mowing resistance indicates that the lawn has already been completely mowed.

The operation data (OD) can be incorporated into the training data set (TD) (with or without user evaluation). By taking into account operation data (OD), in particular operating data of the garden device and/or user input data on the operation result, the AI system can carry out even better operation planning through training than would be possible with the simulative method. In this way, more input variables and boundary conditions

FIG. 3 schematically shows the function of a simulative method with grass growth simulation. Based on the input data (ID), in particular the weather data (WD) and the lawn characteristics data (LCD) and the historical operating data (HOD), the grass growth simulation (201) is first used to estimate grass growth (gg) since the last mowing. The grass growth (gg) is estimated and accumulated for several time periods. The time at which the accumulated grass growth exceeds a threshold for grass growth (tgg) can be considered as the earliest mowing time (EMT). The start time (ST) is planned according to this earliest mowing time (EMT). When planning the time window for operation (TWO), the duration of operation (DO) and various exclusion times (ET), e.g. wet times during and after rain, rest periods or blocking times due to the operation of other garden devices, can be taken into account. The time window for operation can be planned in one or more parts, whereby a minimum duration can also be taken into account for the part.

In the simulation shown in FIG. 3, the input data (weather data, lawn characteristics data, etc.) is used to simulate grass growth (gg) at several time intervals (e.g. hourly or daily) and accumulated over time. On the day marked d1, the user-configured threshold for grass growth (tgg) is expected to be exceeded. The system plans a duration of operation (DO) of 5 hours. The system shown here plans single-part time windows for operation.

The threshold for grass growth (tgg) can be set by the user as the maximum additional grass height until the next mowing.

The system takes into account night times before and after sunset as exclusion times (ET), as well as a predicted rainy period on day 2 (d2) between 10 a.m. and 11 a.m., after which a buffer time is taken into account for drying. In this way, the simulative process with the grass growth simulation (201) plans the next time window for operation for the mowing robot on day 2 (d2) between 12 noon and 5 p.m.

The time window for operation (TWO) proposed by the simulative process can now be submitted to the user for evaluation before, during or after the operation in an evaluation query step (EQ) in order to generate suitable training data (TD) for improving the operational planning based on the user evaluation data. After sufficient training of the AI system (202), the simulative procedure illustrated in FIG. 3 can be replaced by a proposal for the next time window for operation of the AI system.

FIGS. 4, 5 and 6 show possible representations of the time windows for operation (TWO) proposed by the system in an app on a user's terminal device. Preferably, the user has already configured his system at the time shown, i.e. set up his garden device, his lawn to be worked and his user preferences. The system suggests in FIG. 4 the next time window for operation of the garden device (‘smart mowing time’) as Friday, 2 October between 3 p.m. and 9 p.m. (3-9 p.m.). Buttons (‘tell me more’, ‘how do you know’) allow the user to learn more about how this deployment plan was created. In the case of FIG. 4, the user has set the threshold for grass growth (tgg) to 3 cm. This means that the lawn (regardless of the cutting height set in the device) should grow by 3 cm since the last mowing before it is mowed again. This can achieve a significant increase in efficiency in terms of energy consumption and wear on the mowing robot compared to daily mowing. The user also has the option of selecting past mowing operations (‘mowing track’) using a corresponding button.

FIG. 5 shows a possible representation of a multi-part time window for operation on 2 Nov. 2023. Rain is forecast between 8 a.m. and 10 a.m. The system plans the first part of the mowing operation between 11:30 a.m. and 12:30 p.m. An exclusion time between 1 p.m. and 3 p.m., obtained via an IFTTT interface, is taken into account as an interruption of the mowing operation. The second part of the time window for operation is between 3 p.m. and 8 p.m.

The evaluation process can be triggered by the system and/or the user in several ways. For example, the user can start an evaluation query

(EQ) by pressing an evaluation button (e.g. ‘thumbs up’ icon). Alternatively or additionally, the system can prompt the user to enter user evaluation data (UED), for example as a push message.

FIG. 6 shows an example of an evaluation query (EQ) in an app. The evaluation query includes a proposed time window for operation (TWO) with a start time (ST) on 2 November at 3 pm and a duration of operation (DO) of 4 hours. The user can use the appropriate buttons to provide a qualitative and/or quantitative assessment of the start time and/or duration of operation. In FIG. 6, the user can rate the start time and/or duration of operation as positive (‘thumbs up’) or negative (‘thumbs down’).

In an example, the evaluation query is structured in several steps. Preferably, the steps build on each other depending on the evaluation result. For example, a qualitative evaluation can be requested first and only in the case of a negative evaluation a further request, e.g. a qualitative evaluation with direction or a quantitative evaluation with desired explicit values, can be requested.

FIGS. 7 and 8 show examples of a sequence of displays in an app for multi-level evaluations of a time window for operation.

In FIG. 7, the user negatively evaluates the proposed start time (ST) on 2 November at 3 p.m. and positively evaluates the duration of operation (DO) of 4 hours. The user is then prompted to enter the desired start time (DST) by entering the desired date and time.

In FIG. 8, however, the user rates the start time on 2 November at 3 p.m. as positive, but rates the suggested duration of operation (DO) of 4 hours as negative. Accordingly, the user is asked for their desired duration of operation (DDO), which they can enter on a subsequent screen.

In addition to the examples shown in the drawings, the method can be implemented in a variety of other examples. The disclosure also covers all combinable examples that result from combining the individual features disclosed here. In particular, the order of the steps disclosed here can be varied. The claimed method can also be defined with the steps disclosed in the description, whereby the subject of the claim is not limited to the order of these steps.

### LIST OF REFERENCES

100 garden device
101 mowing robot
102 garden tractor
103 mower
110 terminal device
200 operation planning
201 grass growth simulation
202 AI system
210 evaluation process
220 training data generation
221 training data base
230 time window rectification
300 device control
40 control interface
402 message interface
500 training
600 filtering of training data
TWO time window for operation
ST start time
DO duration of operation
RTWO rectified time window for operation
DTWO desired time window for operation
DST desired start time
DDO desired duration of operation
QE qualitative evaluation
d1, d2 day 1, day 2, . . .
gg grass growth, per period
tgg threshold for grass growth
EQ evaluation query
ET exclusion times
EMT earliest mowing time
ID input data
GDD garden device data
WD weather data
UPD user profile data
LCD lawn characteristics data
HOD historic operating data
OD operation data
TD training data set
UED user evaluation data

1. A computer-implemented method for determining a time window (TWO) for a garden device (100) for maintaining a lawn, preferably for a mowing robot (101), a garden tractor (102) or a mower (103), wherein the time window for operation (TWO) is determined based on input data (ID) and by a grass growth simulation (201) and/or by a trained AI system (202), wherein the time window for operation (TWO) comprises at least a start time (ST) and/or a duration of operation (DO) for the operation of the garden device, wherein an evaluation query (EQ) is generated for evaluating the time window for operation (TWO) and the evaluation query (EQ) is provided to a user's terminal device (110), wherein user evaluation data (UED) of the time window for operation (TWO) is retrieved to generate a training data set (TD) for an AI system (202).

2. The computer-implemented method according to claim 1, wherein the user evaluation data (UED) comprises at least one of the following elements: a desired time window for operation (DTWO), a desired start time (DST), a desired duration of operation (DDO) and/or a qualitative evaluation (QE) of the time window for operation.

3. The computer-implemented method according to claim 1, wherein the time window for operation (TWO) is rectified according to the user evaluation data (UED) to form a rectified time window for operation (RTWO), in particular based at least in part on user evaluation occurring before a start of the time window for operation (TWO).

4. The computer-implemented method according to claim 1, wherein the time window for operation (TWO) or a rectified time window for operation (RTWO) of the garden device (100) is provided to a control interface.

5. The computer-implemented method according to claim 1, wherein the training data set (TD′) comprises at least one of the following elements: the input data (ID), the time window for operation (TWO), a rectified time window for operation (RTWO), the user evaluation data (UED) and/or operation data (OD).

6. The computer-implemented method according to claim 1, wherein the input data (ID) includes at least one of the following elements: weather data (WD), garden device data (GDD), user profile data (UPD), lawn characteristics data (LCD), historic operating data (HOD) and/or calendar data (CD).

7. The computer-implemented method according to claim 1, wherein one or more evaluation queries (EQ) are generated before and/or after use of the garden device (100).

8. The computer-implemented method according to claim 1, wherein operation data (OD) is obtained from the garden device (100) in use and/or the user's terminal device (110) when the garden device has already been used.

9. The computer-implemented method according to claim 1, wherein operation data (OD) is processed to generate the evaluation query (EQ) and/or to generate the training data set (TD).

10. The computer-implemented method according to claim 1, wherein a missing user evaluation is evaluated as an implicitly positive evaluation of the time window for operation.

11. The computer-implemented method according to claim 1, wherein at least one training data set (TD′) for training the AI system (202) is stored in a training data base (250).

12. The computer-implemented method according to claim 11, wherein the AI system (202) is trained with a plurality of training data sets (TD) from the training data base (250).

13. The computer-implemented method according to claim 12, wherein the plurlaity of training data sets (TD) are filtered by a plausibility filter.
